(19) United States
(12) Patent Application Publication
(10) Pub. No.: US 2015/0264520 A1
(43) Pub. Date: Sep. 17, 2015

(54) SYSTEM AND METHOD FOR DETERMINING A LOCATION FOR A WIRELESS COMMUNICATION DEVICE USING AN INTEGRATED WIFI SNIFFER AND MEASUREMENT ENGINE

(71) Applicant: QUALCOMM Incorporated, San Diego, CA (US)

(72) Inventors: Stephen Joseph BEAUREGARD, San Jose, CA (US); Praveen DUA, Cupertino, CA (US)

(73) Assignee: QUALCOMM Incorporated, San Diego, CA (US)

(21) Appl. No.: 14/211,861

(22) Filed: Mar. 14, 2014

(51) Int. Cl. H04W 4/02

(52) U.S. Cl. CPC H04W 4/02; H04W 84/12

(57) ABSTRACT

Methods, systems, computer-readable media, and apparatuses for determining a location for a wireless communication device using an integrated WiFi sniffer and measurement engine are presented. The method includes utilizing a first WiFi transceiver and a second WiFi transceiver. Data communications or positioning communications can be transmitted and received on either of the first and the second WiFi transceivers, or both.

### BACKGROUND

Aspects of the disclosure relate to a dedicated WiFi subsystem for implementing a WiFi positioning system. More specifically, aspects of the disclosure relate to implementing a WiFi sniffer, prober, and measurement engine (ME) within a system on a chip (SoC).

Advancements in wireless technology have greatly increased the versatility of today's wireless communication devices. These advancements have enabled wireless communication devices to evolve from simple mobile telephones and pagers into sophisticated computing devices capable of a wide variety of functionality such as multimedia recording and playback, event scheduling, word processing, e-commerce, etc. As a result, users of today's wireless communication devices are able to perform a wide range of tasks from a single, portable device that conventionally required either multiple devices or larger, non-portable equipment. A majority of users keep present their wireless communication device wherever they travel in their everyday lives. Accordingly, many applications running on wireless communication devices make use of location-based services, which may be based on obtained WiFi positioning information.

Current WiFi chips for wireless communication devices are optimized for low-power and reliable data connectivity. However, design requirements for WiFi data connectivity are often times different than design requirements for WiFi positioning. As a result, a majority of existing WiFi chips, designed with a focus on WiFi data connectivity, provide minimum considerations toward WiFi positioning. Thus, in many ways, WiFi data connectivity is “orthogonal” to positioning. For example, upon establishment of WiFi data connectivity, throughput and power consumption may take priority over any other considerations for the WiFi chip. Any extra functionality, such as scanning for access points (APs) for WiFi positioning may be relegated to a lower priority since scanning for additional APs are not of concern because WiFi data connectivity is already established with a single AP.

Further, during deployment of APs for instance, it is beneficial to minimize the number of APs to achieve a desired level of data throughput and connectivity quality of service (QoS). However, for WiFi positioning communications, it is beneficial to have multiple APs placed at different locations relative to the wireless device to reduce dilution of precision (DOP) and accurate positioning. Additionally, for WiFi data connectivity, only bit-level is synchronization is needed. However, for WiFi positioning communications, sub-bit timing resolution is required for ranging communications (e.g., RSSI, RTT, TOA, etc.). Additionally, in WiFi data connectivity communications, APs having poor signal strength are typically ignored and deemed irrelevant because it is likely that their bit error rates would be too high and throughput would be too low to support an acceptable connection. However, for WiFi positioning communications, these APs having poor signal strength can still be leveraged for ranging, especially when they are located at positions that reduce DOP.

As a result of WiFi data connectivity communications having precedence over WiFi positioning communications, the quality of received signal strength indication (RSSI), time of arrival (TOA), and round trip time (RTT) measurements, used for WiFi positioning, are compromised. For example, active and passive AP scanning requests are scheduled to fit in between periods of higher priority WiFi data connectivity requests. Additionally, when the WiFi subsystem is powered down, no WiFi positioning communications may be carried out. For example, systems cannot fuse positioning measurements with Global Navigation Satellite System (GNSS) measurements nor do crowdsourcing in the background without WiFi data connectivity.

Embodiments of the invention address this and other problems, individually and collectively.

### BRIEF SUMMARY

Certain embodiments are described that determine a location for a wireless communication device using an integrated WiFi sniffer and measurement engine,

In some embodiments, the method includes utilizing a first WiFi transceiver coupled to a first radio frequency (RF) chain, via a first RF channel, to perform data communications. The method further includes utilizing a second WiFi transceiver coupled to a second RF chain, via a second RF channel, to perform positioning communications. The method also includes determining a location of the wireless communication device based at least in part on the positioning communications.

In some embodiments, the method additionally includes scanning, via the second WiFi transceiver, for a plurality of WiFi access points (APs) simultaneous to the first WiFi transceiver performing the data communications.

In some embodiments, the first RF chain is coupled to a first antenna system and the second RF chain is coupled to a second antenna system.

In some embodiments, the method additionally includes determining the location of the wireless communication device based at least in part on the data communications and the positioning communications.

In some embodiments, the second WiFi transceiver employs carrier sense multiple access with collision avoidance (CSMA/CA) techniques,

In some embodiments, the second WiFi transceiver is integrated on a system on a chip (SoC), and wherein the SoC comprises a modem and an application processor.

In some embodiments, the first WiFi transceiver is associated with a first media access control (MAC) address and the second WiFi transceiver is associated with a second MAC address.

In some embodiments, the first RF channel operates at 2.4 GHz or 5 GHz and the second RF channel operates at 2.4 GHz or 5 GHz.

In some embodiments, an apparatus for determining a location for a wireless communication device includes a first WiFi transceiver coupled to a first RF chain, via a first RF channel, to perform data communications. The apparatus further includes a second WiFi transceiver coupled to a second RF chain, via a second RF channel, to perform positioning communications. The apparatus also includes a processor coupled to the first WiFi transceiver and the second WiFi transceiver, wherein the processor is configured to determine a location of the wireless communication device based at least in part on the positioning communications.

In some embodiments, an apparatus includes a first means for transmitting and receiving a WiFi signal. The apparatus further includes a second means for transmitting and receiving a WiFi signal. The apparatus also includes means for determining a location of the wireless communication device based at least in part the second means.

In some embodiments, a processor-readable non-transitory medium comprises processor readable instructions that are configured to cause a processor to utilize a first WiFi transceiver coupled to a first radio frequency (RF) chain, via a first RF channel, to perform data communications. The processor readable instructions are further configured to cause the processor to utilize a second WiFi transceiver coupled to a second RF chain, via a second RF channel, to perform positioning communications. The processor readable instructions are also configured to cause the processor to determine a location of the wireless communication device based at least in part on the positioning communications.

In some embodiments, a processor-readable non-transitory medium comprises processor readable instructions that are configured to cause a processor to utilize a first WiFi transceiver coupled to a first radio frequency (RF) chain, via a first RF channel. The processor readable instructions are further configured to cause the processor to utilize a second WiFi transceiver coupled to a second RF chain, via a second RF channel, wherein utilizing the first WiFi transceiver and utilizing the second WiFi transceiver can include performing data communications, performing positioning communications, or both.

### BRIEF DESCRIPTION OF THE DRAWINGS

Aspects of the disclosure are illustrated by way of example. In the accompanying figures, like reference numbers indicate similar elements, and:

FIG. 1 is a block diagram of components of a wireless communication device, according to an embodiment of the present invention;

FIG. 2 is a block diagram of components of two individual WiFi transceivers, within a wireless communication device, having separate antennas, according to an embodiment of the present invention;

FIG. 3 is a block diagram of components of two individual WiFi transceivers, within a wireless communication device, having a shared antenna, according to embodiments of the present invention;

FIG. 4 is a block diagram of components of two individual WiFi transceivers within a SoC on a wireless communication device, according to embodiments of the present invention;

FIG. 5A is an illustrative flow chart depicting an exemplary operation for determining a location of a wireless communication device;

FIG. 5B is another illustrative flow chart depicting an exemplary operation for determining a location of a wireless communication device; and

FIG. 6 illustrates an example of a computing system in which one or more embodiments may be implemented.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims. It can be appreciated that the terms “data communication(s)” and “data connectivity” may be used interchangeably within the following description.

Embodiments of the present invention separate WiFi data connectivity communications from WiFi positioning communications. In some embodiments, a first WiFi transceiver is utilized to perform data communications while a second WiFi transceiver is utilized to perform positioning communications. In some embodiments, both WiFi transceivers may be implemented within a SoC by the SoC manufacturer. In other embodiments, the first WiFi transceiver may be implemented within a SoC while the second WiFi transceiver may be implemented external to the SoC, or vice versa. In yet another embodiment, both WiFi transceivers may be external to a SoC within a wireless communication device. Irrespective of the implementation, the first WiFi transceiver may operate separately from the second WiFi transceiver. Additionally, in a scenario where the first transceiver and the second transceiver are manufactured by different manufacturers, minimal coordination is necessary between the two as a result of carrier sense multiple access with collision avoidance (CSMA/CA) techniques, which are well known in the art. That is, it is possible for the operation of one WiFi transceiver to not interfere with the operation of the other.

### Wireless Communication Device

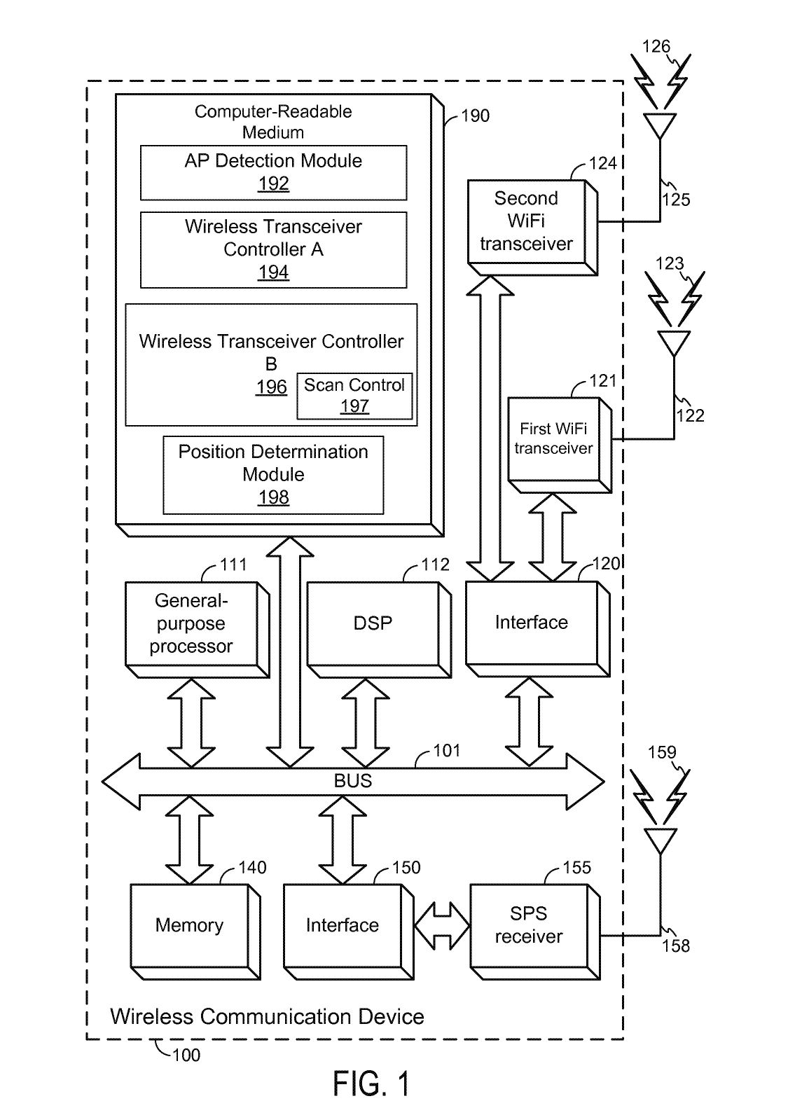

FIG. 1 illustrates is a block diagram of components of a wireless communication device 100, according to an embodiment of the present invention. Wireless communication device 100 includes a first WiFi transceiver 121 that sends and receives first wireless signals 123 via a first wireless antenna 122 over a wireless network. Wireless communication device 100 also includes a second WiFi transceiver 124 that sends and receives second wireless signals 126 via a second wireless antenna 122 over a second wireless network. The first WiFi transceiver 121 and second WiFi transceiver 124 are connected to a bus 101 by a wireless transceiver bus interface 120. While shown as distinct components in FIG. 1, the wireless transceiver bus interface 120 may also be a part of either the first WiFi transceiver 121 or second WiFi transceiver 124. Additionally, each wireless transceiver may be coupled to a separate wireless interface. That is, the first WiFi transceiver 121 may be coupled to a first wireless interface and the second wireless transceiver may be coupled to a second wireless interface. The WiFi transceivers 121 and 124 and wireless antennas 122 and 125 may support multiple communication standards such as WiFi, Code Division Multiple Access (CDMA), Wideband CDMA (WCDMA), Long Term Evolution (LTE), Bluetooth, etc. In embodiments of the present invention, the WiFi transceivers 121 and 124 will be described as WiFi transceivers, but are in no way limited to the WiFi communication standard. In some embodiments, the first WiFi transceiver 121 may be utilized to perform data communications and the second WiFi transceiver 124 may be utilized to perform positioning communications, or vice versa.

A general-purpose processor 111, mory 140, digital signal processor (DSP) 112 and/or specialized processor(s) (not shown) may also be utilized to process the wireless signals 123, 126 in whole or in part. Storage of information from the wireless signals 123, 126 is performed using a memory 140 or registers (not shown). While only one general purpose processor 111, DSP 112 and memory 140 are shown in FIG. 1, more than one of any of these components could be used by the wireless communication device 100. The general purpose processor 111, DSP 112 and memory 140 are connected to the bus 101.

The wireless communication device 100 also includes an SPS receiver 155 that receives SPS signals 159 (e.g., from SPS satellites) via an SPS antenna 158. The SPS receiver 155 processes, in whole or in part, the SPS signals 159 and uses these SPS signals 159 to determine the location of the wireless communication device 100. The general-purpose processor 111, memory 140, DSP 112 and/or specialized processor(s) (not shown) may also be utilized to process the SPS signals 159, in whole or in part, and/or to calculate the location of the wireless communication device 100, in conjunction with SPS receiver 155. Storage of information from the SPS signals 159 or other location signals is performed using a memory 140 or registers (not shown).

The wireless communication device 100 also includes a non-transitory computer-readable storage medium 190 (or media) that stores functions as one or more instructions or code. Media that can make up the computer-readable storage medium 190 include, but are not limited to, RAM, ROM, FLASH, disc drives, etc. Functions stored by the computer-readable storage medium 190 are executed by the general-purpose processor 111, specialized processor(s), or DSP 112. Thus, the computer-readable storage medium 190 is a processor-readable memory and/or a computer-readable memory that stores software (programming code, instructions, etc.) configured to cause the processor 111 and/or DSP 112 to perform the functions described. Alternatively, one or more functions of the wireless communication device 100 may be performed in whole or in part in hardware.

Computer-readable storage medium 190 includes AP detection module 192, wireless transceiver controller A 194, wireless transceiver controller B 196, and position determination module 198.

AP detection module 192 is configured to detect APs currently within communication range of the wireless communication device 100. AP detection module 192 may interface with the second WiFi transceiver 124 via interface 120 and bus 101 to detect APs currently within communication range of the wireless communication device 100. Detection of the APs may be accomplished using detection methods supported by multiple communication standards such as WiFi, Code Division Multiple Access (CDMA), Wideband CDMA (WCDMA), Long Term Evolution (LTE), Bluetooth, etc. In some embodiments, the AP detection module 192 may perform certain positioning communications. For example, the AP detection module 192 may instruct the second WiFi transceiver 124, via wireless transceiver controller B 196 (described below), to transmit a RSSI or RTT communication. The AP detection module 192 may also instruct the second WiFi transceiver 124, via wireless transceiver controller B 196, to receive a response to the RSSI or RTT communication and forward the response to the position determination module 198 (described below).

Wireless transceiver controller A 194 is configured to manage the first WiFi transceiver 121. Wireless transceiver controller A 194 may also configure the first WiFi transceiver 121. For example, wireless transceiver controller A 194 may configure the first WiFi transceiver 121 to perform data communications only. Wireless transceiver controller A 194 may also instruct the first WiFi transceiver 121 to carry out certain communications, e.g., transmitting certain data communications as described above. Further, wireless transceiver controller A 194 may also perform functions such as interference detection and avoidance, load balancing, and RF management.

Wireless transceiver controller B 196 is configured to manage the second WiFi transceiver 124. For example, wireless transceiver controller B 196 may configure the second WiFi transceiver 124 to perform positioning communications only. Wireless transceiver controller B 196 may also instruct the second WiFi transceiver 124 to carry out certain communications, e.g., transmitting and/or receiving RSSI or RTT communications as described above. Further, wireless transceiver controller B 196 may also perform functions such as interference detection and avoidance, load balancing, and RF management.

Wireless transceiver controller B 196 may also include scan control module 197. The scan control module 197 may control a Wi-Fi sniffer (within the second WiFi transceiver 124 and described in further detail below) to detect APs to be used for positioning communications. The scan control module 197 may also interface with the AP detection module 192 FIG. 1. For example, the AP detection module 192 FIG. 1 may initiate detection of APs to be used for positioning communications. In turn, the scan control module 197 may select a channel for the WiFi sniffer to scan. Once the WiFi sniffer detects one or more APs, the detected APs may be reported back to the AP detection module 192.

The position determination module 198 is configured to determine a location of the wireless communication device 100. The location may be determined based on RSSI, RTT, and/or TOA values received by AP detection module 192. The obtained RSSI, RTT, and/or TOA values may be compared against a heatmap containing expected RSSI, RTT, and/or TOA values for a particular AP. The location of the wireless communication device 100 may be determined at least partly based on the comparison and known trilateration techniques.

### Separate Data Connectivity WiFi Transceiver and Positioning Communications WiFi Transceiver

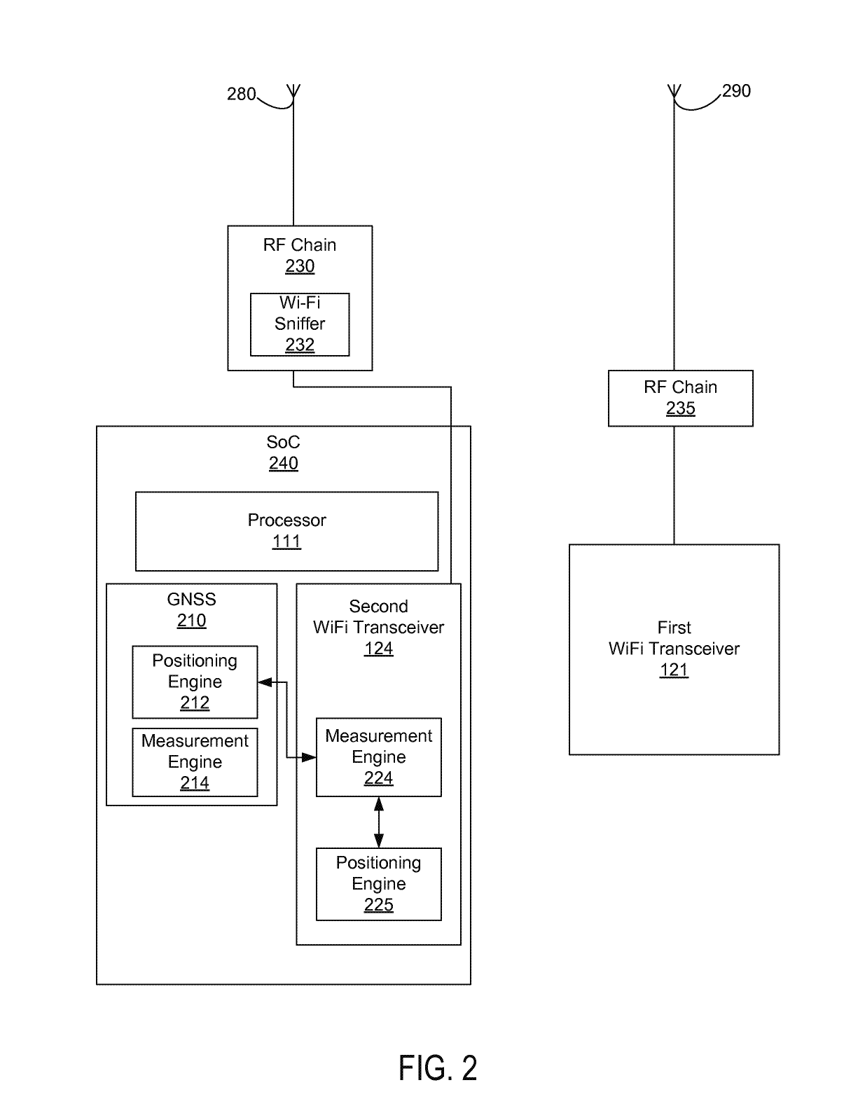

FIG. 2 is a block diagram of components of two individual MR transceivers 121 and 124, within a wireless communication device, having separate antennas 280 and 290, according to an embodiment of the present invention. FIG. 2 shows further details of components within and associated with the components described with respect to FIG. 1. Additionally, even though FIG. 2 may show elements that are not shown in FIG. 1, it may be assumed that these elements are part of the wireless communication device 100 shown in FIG. 1. The individual WiFi transceivers 121 and 124 illustrate the separation and individualization of data connectivity and positioning communications within a wireless communication device. That is, a first WiFi transceiver 121 utilized for data connectivity is separate from a second WiFi transceiver 124 utilized for positioning communications. The first WiFi transceiver 121 may be a separate wireless chip within the wireless communication device while the second WiFi transceiver 124 may be embedded within a SoC 240 within the wireless communication device.

The SoC 240, although not depicted in FIG. 1, may include many of the components described with respect to FIG. 1. The SoC 240 includes the second WiFi transceiver 124 utilized for positioning communications and a GNSS chip 210. The GNSS chip 210 may include a positioning engine 212 and a measurement engine 214. In some embodiments, GNSS positioning may be used in conjunction with WiFi based positioning techniques. However, it can be appreciated that the WiFi based positioning techniques described herein can operate entirely independently of any GNSS implementation.

The second WiFi transceiver 124 may include a measurement engine 224 and a positioning engine 225. Additionally, the second WiFi transceiver 124 may be coupled to an RF chain 230 (e.g., radio) that includes a WiFi sniffer 232. The RF chain 230 may also include other components which are well known in the art, e.g., encoder, modulator, IFFT, filter, DAC/ADC, etc. The RF chain 230 may also be coupled to an RF antenna 280.

The WiFi sniffer 232 may be operable to scan for and detect APs within a WiFi geospace that may be used for positioning communications. The scan control module 197 (FIG. 1) may control the Wi-Fi sniffer 232 to detect APs to be used for positioning communications. As described above, the scan control module 197 (FIG. 1) may also interface with the AP detection module 192 (FIG. 1). In some embodiments, the scan control module 197 (FIG. 1) may select a channel for the WiFi sniffer 232 to scan. Once the WiFi sniffer 232 detects one or more APs, the detected APs may be reported back to the AP detection module 192 (FIG. 1). The position determination module 198 (FIG. 1) may then interface with the measurement engine 224 to obtain position measurements from the detected APs. Once the measurement engine 224 obtains the position measurements from the detected APs, the position determination module 198 (FIG. 1) may determine a position of the wireless communication device 100 by interfacing with the positioning engine 225.

The WiFi sniffer 232 may be employed in different modes, and it may be implemented in different configurations. In some embodiments, the WiFi sniffer 232 may be continuously scanning for APs. That is, the WiFi sniffer 232 may passively scan for APs rather than transmitting a probe request and receiving a probe response. In some embodiments, the WiFi sniffer 232 may be embedded within the second WiFi transceiver 124. The SoC 240 also includes a processor 111, which may be the general purpose processor 111 (FIG. 1) embedded within the SoC 240.

The first WiFi transceiver 121 is also coupled to an individual RF chain 235 (e.g., radio). The RF chain 235 coupled to the WiFi transceiver 121 may include similar components to those described above, e.g., encoder, modulator, IFFT, filter, DAC/ADC, etc. The RF chain 235, similar to RF chain 230, is coupled to an individual RF antenna 290. That is, the implementation in FIG. 2 includes two WiFi transceivers 121 and 124, coupled to separate RF chains 230, 235 and separate RF antennas 280 and 290 respectively. It can be appreciated that RF antenna 280 and RF antenna 290 may be different types of antennas and also may comprise different antenna characteristics. In some embodiments, however, RF antenna 280 and RF antenna 290 may be substantially similar.

In some embodiments, one or both of the first WiFi transceiver 121 and the second WiFi transceiver 124 may use direct RF-to-baseband sampling, avoiding the need for an additional RF chip within the wireless communication device 100. Additionally, by using direct RF-to-baseband sampling, a significant portion of the RF receive front end may be eliminated and shifted to digital signal processing (DSP) in the WiFi transceiver baseband within the SoC. This may allow for leveraging of software-defined or cognitive radio functions for positioning, for example, compressed sensing of multiple WiFi channels simultaneously (e.g., AP beacons), fast channel hopping, band spectral analysis, etc. Software-defined or cognitive radio functions may not typically be used in high-throughput WiFi data connectivity solutions due to significant power consumption associated with them. In contrast, for positioning communications, software-defined or cognitive radio functions may provide a significant increase in measurement capabilities and options without the power consumption associated with high-throughput WiFi data, due to lower throughput and a lower Rx/Tx duty cycle. Furthermore, by having separate RF chains for the individual WiFi transceivers, the second WiFi transceiver 124 may be designed with increased sensitivity in order to detect very distant APs for better DOP. By having a separate RF chain, the second WiFi transceiver 124 may scan and dwell on channels as long as required, particularly those not being used by the first WiFi transceiver 121.

In some embodiments, the second WiFi transceiver 124 may exclusively perform positioning communications while the first WiFi transceiver 121 may exclusively perform data connectivity communications. Furthermore, in some embodiments, RF chain 230 and RF chain 235 may operate on different RF channels. For example, RF chain 230 may operate at 2.4 GHz and RF chain 235 may operate at 5 GHz, or vice versa. In other embodiments, both RF chain 230 and RF chain 235 may operate at 2.4 GHz. In other embodiments, both RF chain 230 and RF chain 235 may operate at 5 GHz. Additionally, the second WiFi transceiver 124 and the first WiFi transceiver 121 may comprise different MAC addresses.

Often times, the WiFi transceiver within the SoC 240 may be left unused due to an external (e.g., external to the SoC 240) WiFi chip within the wireless communication device 100 (FIG. 1). In these implementations, the external WiFi chip may primarily perform data connectivity and secondarily perform positioning communications, resulting in degraded positioning measurements as described above. Thus, in some embodiments, the unused WiFi transceiver may be repurposed from an unused state in the SoC 240 certain Qualcomm MSM-series and APQ-series SoC products) to implement the components of the second WiFi transceiver 124 depicted in FIG. 2. Accordingly, the first WiFi transceiver 121 may be utilized to perform data connectivity communications exclusively, since the second WiFi transceiver 124 may be utilized to perform the positioning communications. As a result, the second WiFi transceiver 124 is optimized for positioning functionality and may have limited data connectivity capability. In other words, the positioning communications performed by the second WiFi transceiver 124 may be completely independent of the data connectivity communications performed by the first WiFi transceiver 121. Accordingly, it can be appreciated that positioning communications may be performed even without data connectivity communications.

In an example of the implementation described in FIG. 2, the first WiFi transceiver 121 may scan for a single AP within a WiFi geospace while the second WiFi transceiver 121 may scan many APs within the WiFi geospace. The first WiFi transceiver 121 may provide better QoS when connected to a single AP having the maximum signal strength. While on the other hand, for optimal positioning communications, the second WiFi transceiver 124 may provide better positioning measurements that are ultimately used in position determination with a multitude of detected APs for better DOP, as described above. It can be appreciated that, for the above reasons, the second WiFi transceiver 124 may be implemented with increased sensitivity for detecting APs than the first WiFi transceiver 121. Furthermore, the measurement engine 224 of the second WiFi transceiver 124 may receive multiple RSSI, RTT, TOA, or other position measurements from different channels/bands simultaneously, thus increasing efficiency and accuracy.

It can be appreciated that minimal design considerations may be necessary to execute the implementation described in FIG. 2. Any concern of interference caused by, or having to coordinate between, the two separate WiFi transceivers may be alleviated by the use of standard mechanisms already implemented as part of the communication protocol, such as IEEE 802.11 CSMA/CA mechanisms, which are well known in the art.

It can also be appreciated that the second WiFi transceiver 124 may only require positioning operation functions defined in its firmware, according to one embodiment of the invention. That is, almost all data connectivity functions in the second WiFi transceiver's 124 firmware may be unnecessary. Additionally, the firmware could be optimized in a number of ways: e.g., fine tuning the burst timing cost function (BTCF), implementing smart active channel scanning for both Rx and Tx, implementing smart channel passive scanning, implementing low-level measurement filtering and tracking, and leveraging Cisco® Compatible Extensions (CCX) messages in firmware.

Thus, by separating WiFi data connectivity communications from WiFi positioning communications, the quality of RSSI, RTT, TOA, and other positioning measurements may be improved. For example, raw measurements may be pre-filtered (e.g., using a Kalman filter) to remove large outliers and to estimate states (e.g., line of sight and non-line of sight propagation flags) before forwarding them to a positioning engine (PE). This type of pre-filtering is difficult to perform when WiFi positioning communications are carried out on the same WiFi transceiver utilized for data connectivity because data connectivity typically has a higher priority and thus monopolizes computing and memory resources of the wireless communication device. Additionally, a separate WiFi transceiver for positioning communications may conduct positioning measurements and preprocess the results without intervention from the processor. For instance, background crowdsourcing and geofencing may be implemented at low power.

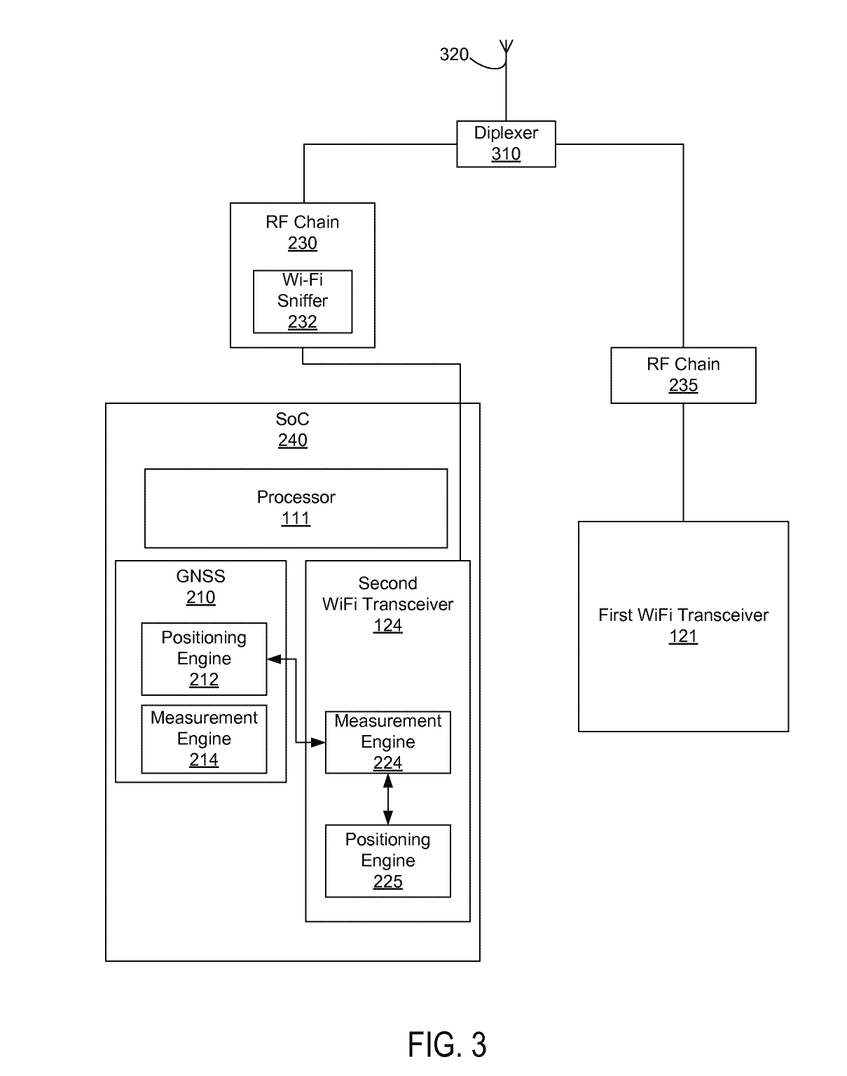

FIG. 3 is a block diagram of components of two individual MR transceivers 121 and 124, within a wireless communication device, having a shared antenna system 320, according to embodiments of the present invention. FIG. 3 is similar to FIG. 2, except that RF chain 230 and RF chain 235 are coupled to a single RF antenna system 320 via a diplexer. In this embodiment of the invention, both the second WiFi transceiver 124 and the first WiFi transceiver 121 may be utilized for their respective communications using one single RF antenna system 320. As such, there is no need for a separate RF antenna for each transceiver's RF chain. The diplexer 310 may be operable to implement frequency domain multiplexing, so that there is no interference between communications transmitted and received by the second WiFi transceiver 124 and the first WiFi transceiver. In some embodiments, the diplexer 310 is a passive device having no notion of input or output. The use of the diplexer 310 and the single RF antenna system 320 in this embodiment may provide for manufacturing efficiency and cost savings from the use of a single communications channel. As described above, standard IEEE 802.11 CSMA/CA mechanisms may also be used to reduce any potential interference.

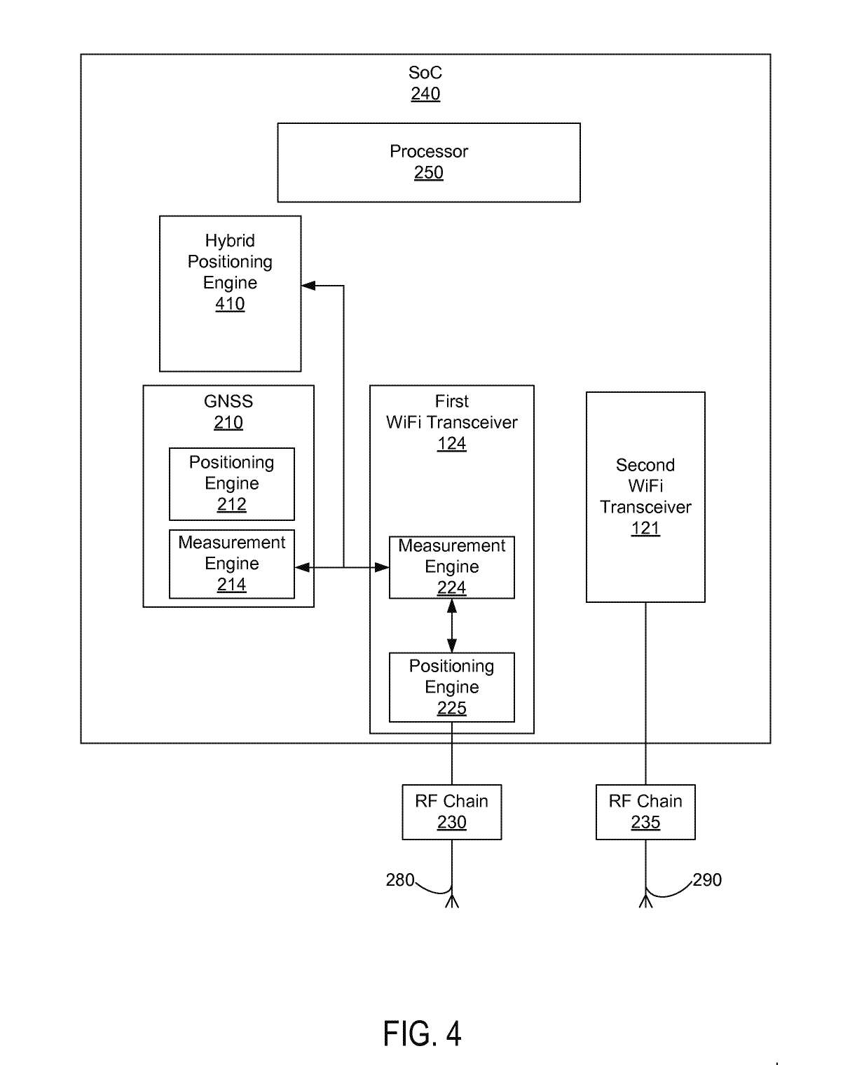

FIG. 4 is a block diagram of components of two individual WiFi transceivers 121 and 124 within a SoC 240 on a wireless communication device, according to embodiments of the present invention. FIG. 4 is similar to FIG. 2 except that both the second WiFi transceiver 124 and the first WiFi transceiver 121 are embedded within the SoC 240 within the wireless communication device 100 (FIG. 1). By embedding both transceivers on the SoC 240, manufacturers of the SoC 240 may provide a one-stop solution for wireless communication devices 100 that includes separate WiFi transceivers individually dedicated for positioning communications and data connectivity communications. The embodiment in FIG. 4 may also include the use of a hybrid positioning engine 410. The hybrid positioning engine 410 may allow for measurements from the GNSS measurement engine 214 and measurements from the positioning communications measurement engine 224 to be combined in the position determination, resulting in more accurate position determination. The hybrid positioning engine 410 leverages the individual strengths of both the GNSS chip 210 and the second WiFi transceiver 124. In some embodiments, the hybrid positioning engine 410 may determine whether the measurements from the GNSS measurement engine 214 or measurements from the positioning communications measurement engine 224 are more reliable, and use the more reliable measurements in the position determination operation. In other embodiments, measurements from the two measurement engines 214 and 224 may be synthesized by the hybrid positioning engine 410.

### Method for Determining a Location of a Wireless Communication Device

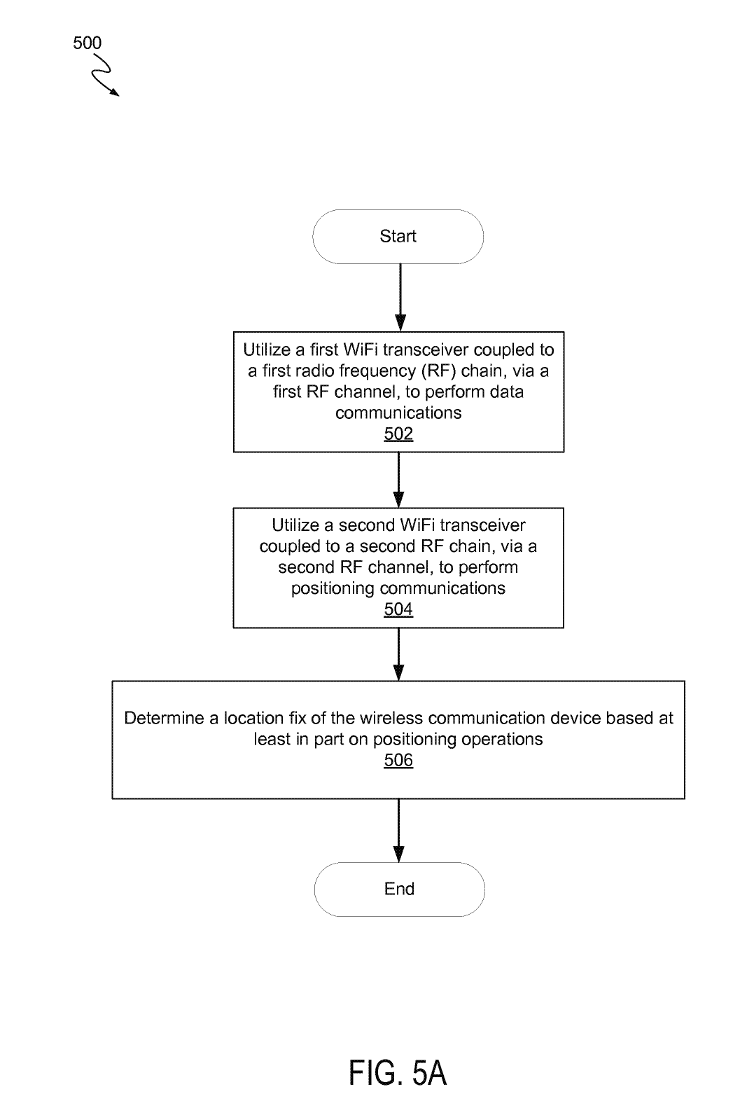

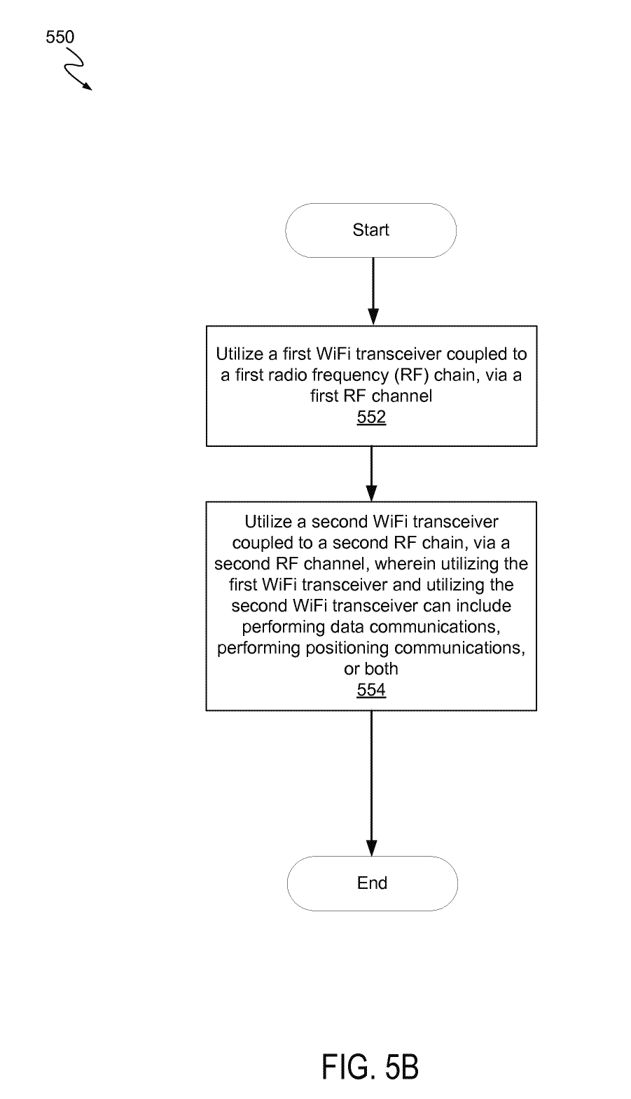

FIG. 5A is an illustrative flow chart 500 depicting an exemplary operation for determining a location of a wireless communication device. In block 502, a first WiFi transceiver coupled to a first RF chain, via a first RF channel, is utilized to perform data communications. For example, in FIG. 2, the first WiFi transceiver is coupled to the RF chain via the first channel. The first WiFi transceiver is utilized to perform data connectivity communications, rather than both data communications and positioning communications.

In block 504, a second WiFi transceiver coupled to a second RF chain, via a second RF channel, is utilized to perform positioning communications. For example, in FIG. 2, the second WiFi transceiver is coupled to the RF chain via the first channel. The RF chain includes the WiFi sniffer, among other components. The second WiFi transceiver is utilized to perform positioning communications. In some embodiments, one of the first RF channel and the second RF channel operates at 2.4 GHz and the other of the first RF channel and the second RF channel operates at 5 GHz. In other embodiments, both the first RF channel and the second RF channel may operate at 2.4 GHz. In other embodiments, both first RF channel and second RF channel may operate at 5 GHz.

In some embodiments, the second WiFi transceiver may scan for a plurality of WiFi APs, while the first WiFi transceiver simultaneously performs data communications. For example, in FIG. 2, the second WiFi transceiver may scan for a plurality of APs within the WiFi geospace simultaneous to the first WiFi transceiver performing data communications.

In some embodiments, the first RF chain is coupled to a first antenna system and the second RF chain is coupled to a second antenna system. For example, in FIG. 2, the first RF chain is coupled the first antenna system and the second RF chain is coupled to the second antenna system. The two antennas may be of different types and have different characteristics, or they may be substantially similar.

In other embodiments, the first RF chain and the second RF chain are coupled to an antenna, via a diplexer. For example, in FIG. 3, the first RF chain and the second RF chain are coupled to the same antenna via a diplexer. The diplexer multiplexes the communications from both the RF chains.

In some embodiments, the second WiFi transceiver employs CSMA/CA techniques. For example, in FIG. 2, the second WiFi transceiver employs CSMA/CA to avoid any interference or collisions with communications to and from the first WiFi transceiver.

In some embodiments, the second WiFi transceiver is integrated on a SoC, and the SoC comprises a modem and an application processor. For example, in FIG. 2, the second WiFi transceiver is integrated within the SoC. The second WiFi transceiver may be repurposed from a substantially unused device.

In some embodiments, the first WiFi transceiver is associated with a first MAC address and the second WiFi transceiver is associated with a second MAC address. For example, in FIG. 2, the second WiFi transceiver and the first WiFi transceiver may be associated with different MAC addresses.

In block 506, a location of the wireless communication device is determined, based at least in part on the positioning communications. For example, in FIG. 1, the position determination module, together with the positioning engine in FIG. 2, determines a location of the wireless communication device. In some embodiments, the location of the wireless communication device may be determined, based at least in part on the data communications from the first WiFi transceiver and positioning communications from the second WiFi transceiver.

FIG. 5B is an illustrative flow chart 550 depicting an exemplary operation for determining a location of a wireless communication device. In block 552, a first WiFi transceiver is coupled to a first RF chain, via a first RF channel. For example, in FIG. 2, the first WiFi transceiver is coupled to the first RF chain via the first channel.

In block 554, a second WiFi transceiver is coupled to a second RF chain, via a second RF channel. For example, in FIG. 2, the second WiFi transceiver is coupled to the second RF chain via the second channel. In some embodiments, utilizing the first WiFi transceiver and utilizing the second WiFi transceiver can include performing data communications, performing positioning communications, or both. For example, in FIG. 2, the first WiFi transceiver can be utilized to perform data communications, performing positioning communications, or both. Additionally, in FIG. 2, the second WiFi transceiver can be utilized to perform data communications, performing positioning communications, or both

### Exemplary Computing System

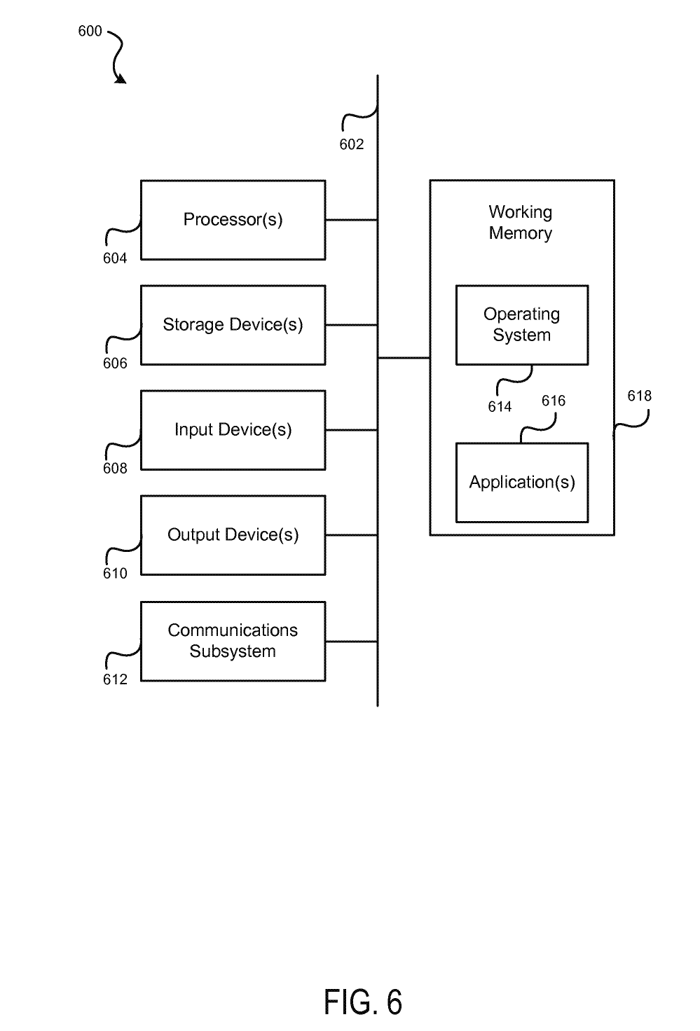

FIG. 6 illustrates an example of a computing system in which one or more embodiments may be implemented. A computer system as illustrated in FIG. 6 may be incorporated as part of the above described computerized device. For example, computer system 600 can represent some of the components of a television, a computing device, a server, a desktop, a workstation, a control or interaction system in an automobile, a tablet, a netbook or any other suitable computing system. A computing device may be any computing device with an image capture device or input sensory unit and a user output device. An image capture device or input sensory unit may be a camera device. A user output device may be a display unit. Examples of a computing device include but are not limited to video game consoles, tablets, smart phones and any other hand-held devices. FIG. 6 provides a schematic illustration of one embodiment of a computer system 600 that can perform the methods provided by various other embodiments, as described herein, and/or can function as the host computer system, a remote kiosk/terminal, a point-of-sale device, a telephonic or navigation or multimedia interface in an automobile, a computing device, a set-top box, a table computer and/or a computer system. FIG. 6 is meant only to provide a generalized illustration of various components, any or all of which may be utilized as appropriate. FIG. 6, therefore, broadly illustrates how individual system elements may be implemented in a relatively separated or relatively more integrated manner. In some embodiments, computer system 600 may be used to implement functionality of the wireless communication device in FIG. 1.

The computer system 600 is shown comprising hardware elements that can be electrically coupled via a bus 602 (or may otherwise be in communication, as appropriate). The hardware elements may include one or more processors 604, including without limitation one or more general-purpose processors and/or one or more special-purpose processors (such as digital signal processing chips, graphics acceleration processors, and/or the like); one or more input devices 608, which can include without limitation one or more cameras, sensors, a mouse, a keyboard, a microphone configured to detect ultrasound or other sounds, and/or the like; and one or more output devices 610, which can include without limitation a display unit such as the device used in embodiments of the invention, a printer and/or the like.

In some implementations of the embodiments of the invention, various devices 608 and output devices 610 may be embedded into interfaces such as display devices, tables, floors, walls, and window screens. Furthermore, input devices 608 and output devices 610 coupled to the processors may form multi-dimensional tracking systems.

The computer system 600 may further include (and/or be in communication with) one or more non-transitory storage devices 606, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 600 might also include a communications subsystem 612, which can include without limitation a modem, a network card (wireless or wired), an infrared communication device, a wireless communication device and/or chipset (such as a Bluetooth™ device, an 802.11 device, a WiFi device, a WiMax device, cellular communication facilities, etc.), and/or the like. The communications subsystem 612 may permit data to be exchanged with a network, other computer systems, and/or any other devices described herein. In many embodiments, the computer system 600 will further comprise a non-transitory working memory 618, which can include a RAM or ROM device, as described above.

The computer system 600 also can comprise software elements, shown as being currently located within the working memory 618, including an operating system 614, device drivers, executable libraries, and/or other code, such as one or more application programs 616, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 606 described above. In some cases, the storage medium might be incorporated within a computer system, such as computer system 600. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed. In some embodiments, one or more elements of the computer system 600 may be omitted or may be implemented separate from the illustrated system. For example, the processor 604 and/or other elements may be implemented separate from the input device 608. In one embodiment, the processor is configured to receive images from one or more cameras that are separately implemented. In some embodiments, elements in addition to those illustrated in FIG. 6 may be included in the computer system 600.

Some embodiments may employ a computer system (such as the computer system 600) to perform methods in accordance with the disclosure. For example, some or all of the procedures of the described methods may be performed by the computer system 600 in response to processor 604 executing one or more sequences of one or more instructions (which might be incorporated into the operating system 614 and/or other code, such as an application program 616) contained in the working memory 618. Such instructions may be read into the working memory 618 from another computer-readable medium, such as one or more of the storage device(s) 606. Merely by way of example, execution of the sequences of instructions contained in the working memory 618 might cause the processor(s) 604 to perform one or more procedures of the methods described herein.

The terms “machine-readable medium” and “computer-readable medium,” as used herein, refer to any medium that participates in providing data that causes a machine to operate in a specific fashion in some embodiments implemented using the computer system 600, various computer-readable media might be involved in providing instructions/code to processor(s) 604 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 606. Volatile media include, without limitation, dynamic memory, such as the working memory 618. Transmission media include, without limitation, coaxial cables, copper wire and fiber optics, including the wires that comprise the bus 602, as well as the various components of the communications subsystem 612 (and/or the media by which the communications subsystem 612 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 604 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 600. These signals, which might be in the form of electromagnetic signals, acoustic signals, optical signals and/or the like, are all examples of carrier waves on which instructions can be encoded, in accordance with various embodiments of the invention.

The communications subsystem 612 (and/or components thereof) generally will receive the signals, and the bus 602 then might carry the signals (and/or the data, instructions, etc. carried by the signals) to the working memory 618, from which the processor(s) 604 retrieves and executes the instructions. The instructions received by the working memory 618 may optionally be stored on a non-transitory storage device 606 either before or after execution by the processor(s) 604.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments are described as processes depicted as flow diagrams or block diagrams. Although each may describe the operations as a sequential process, many of the operations can be performed in parallel or concurrently. In addition, the order of the operations may be rearranged. A process may have additional steps not included in the figures. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks. Thus, in the description above, functions or methods that are described as being performed by the computer system may be performed by a processor—for example, the processor 604—configured to perform the functions or methods. Further, such functions or methods may be performed by a processor executing instructions stored on one or more computer readable media.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

Various examples have been described. These and other examples are within the scope of the following claims.

What is claimed is:

1. A method for determining a location for a wireless communication device, comprising:
utilizing a first WiFi transceiver coupled to a first radio frequency (RF) chain, via a first RF channel, to perform data communications;
utilizing a second WiFi transceiver coupled to a second RF chain, via a second RF channel, to perform positioning communications; and
determining the location of the wireless communication device based at least in part on the positioning communications.

2. The method of claim 1, further comprising scanning, via the second WiFi transceiver, for a plurality of WiFi access points (APs) simultaneous to the first WiFi transceiver performing the data communications.

3. The method of claim 1, wherein the first RF chain is coupled to a first antenna system and the second RF chain is coupled to a second antenna system.

4. The method of claim 1, further comprising determining the location of the wireless communication device based at least in part on the data communications and the positioning communications.

5. The method of claim 1, wherein the second WiFi transceiver employs Carrier sense multiple access with collision avoidance (CSMA/CA) techniques.

6. The method of claim 1, wherein the second WiFi transceiver is integrated on a system on a chip (SoC), and wherein the SoC comprises a modem and an application processor.

7. The method of claim 1, wherein the first WiFi transceiver is associated with a first media access control (MAC) address and the second WiFi transceiver is associated with a second MAC address.

8. The method of claim 1, wherein the first RF channel operates at 2.4 GHz or 5 GHz and the second RF channel operates at 2.4 GHz or 5 GHz.

9. An apparatus for determining a location for a wireless communication device, comprising:
a first WiFi transceiver coupled to a first RF chain, via a first RF channel, to perform data communications;
a second WiFi transceiver coupled to a second RF chain, via a second RF channel, to perform positioning communications; and
a processor coupled to the first WiFi transceiver and the second WiFi transceiver, wherein the processor is configured to determine the location of the wireless communication device based at least in part on the positioning communications.

10. The apparatus of claim 9, wherein the processor is further configured to scan, via the second WiFi transceiver, for a plurality of WiFi access points (APs) simultaneous to the first WiFi transceiver performing the data communications.

11. The apparatus of claim 9, wherein the first RF chain is coupled to a first antenna system and the second RF chain is coupled to a second antenna system.

12. The apparatus of claim 9, wherein the processor is further configured to determine the location of the wireless communication device based at least in part on the data communications and the positioning communications.

13. The apparatus of claim 9, wherein the second WiFi transceiver employs carrier sense multiple access with collision avoidance (CSMA/CA) techniques.

14. The apparatus of claim 9, wherein the second WiFi transceiver is integrated on a system on a chip (SoC), and wherein the SoC comprises a modem and an application processor.

15. The apparatus of claim 9, wherein the first transceiver is associated with a first media access control (MAC) address and the second WiFi transceiver is associated with a second MAC address.

16. The apparatus of claim 9, wherein the first RF channel operates at 2.4 GHz or 5 GHz and the second RF channel operates at 2.4 GHz or 5 GHz.

17. An apparatus for determining a location for a wireless communication device, comprising:
a first means for transmitting and receiving a WiFi signal;
a second means for transmitting and receiving a WiFi signal; and
means for determining the location of the wireless communication device based at least in part on the second means.

18. The apparatus of claim 17, further comprising means for scanning, via the second means, for a plurality of WiFi access points (APs) simultaneous to the first means performing data communications.

19. The apparatus of claim 17, wherein the first means is coupled to a first radio (RF) chain and the first RF chain is coupled to a first antenna system, and wherein the second means is coupled to a second RF chain and the second RF chain is coupled to a second antenna system.

20. The apparatus of claim 17, further comprising means for determining the location of the wireless communication device based at least in part on signals received from both the first means and the second means.

21. The apparatus of claim 17, wherein the second means employs carrier sense multiple access with collision avoidance (CSMA/CA) techniques.

22. The apparatus of claim 17, wherein the second means is integrated on a system on a chip (SoC), and wherein the SoC comprises a modem and an application processor.

23. The apparatus of claim 17, wherein the first means is associated with a first media access control (MAC) address and the second means is associated with a second MAC address.

24. A processor-readable non-transitory medium comprising processor readable instructions configured to cause a processor to:
utilize a first WiFi transceiver coupled to a first radio frequency (RF) chain, via a first RF channel, to perform data communications;
utilize a second WiFi transceiver coupled to a second RF chain, via a second RF channel, to perform positioning communications; and
determine a location of a wireless communication device based at least in part on the positioning communications.

25. The processor-readable non-transitory medium of claim 24, wherein the processor readable instructions are further configured to cause the processor to scan, via the second WiFi transceiver, for a plurality of WiFi access points (APs) simultaneous to the first WiFi transceiver performing the data communications.

26. The processor-readable non-transitory medium of claim 24, wherein the first RF chain is coupled to a first antenna system and the second RF chain is coupled to a second antenna system.

27. The processor-readable non-transitory medium of claim 24, wherein the processor readable instructions are further configured to cause the processor to determine the location of the wireless communication device based at least in part on the data communications and the positioning communications.

28. The processor-readable non-transitory medium of claim 24, wherein the second WiFi transceiver employs carrier sense multiple access with collision avoidance (CSMA/CA) techniques.

29. The processor-readable non-transitory medium of claim 24, wherein the second WiFi transceiver is integrated on a system on a chip (SoC), and wherein the SoC comprises a modem and an application processor.

30. The processor-readable non-transitory medium of claim 24, wherein the first WiFi transceiver is associated with a first media access control (MAC) address and the second WiFi transceiver is associated with a second MAC address.
